(19) United States
(12) Patent Application Publication
(10) Pub. No.: US 2025/0365229 A1
(43) Pub. Date: Nov. 27, 2025

(54) ANYCAST GATEWAY FOR SHORTEST PATH BRIDGING - MEDIA ACCESS CONTROL

(71) Applicant: Extreme Networks, Inc., San Jose, CA (US)

(72) Inventors: Daniel Smith, Indianapolis, IN (US); Roger LAPUH, Uesslingen (CH); Constantin BARCARU, Brasov (RO); Ludovico STEVENS, La Roquette sur Siagne (FR)

(73) Assignee: Extreme Networks, Inc., San Jose, CA (US)

(21) Appl. No.: 18/671,370

(22) Filed: May 22, 2024

(51) Int. Cl. H04L 45/02; H04L 45/50; H04L 45/74

(52) U.S. Cl. CPC H04L 45/04; H04L 45/50; H04L 45/74

(57) ABSTRACT

Disclosed herein are system, method, and computer program product aspects for implementing anycast gateways. Some aspects of this disclosure relate to a method including receiving, by an access node, a first TLV from a first gateway. The first TLV includes a CMAC address for the first gateway, an IP address of the first gateway, and an L2 I-SID associated with the first gateway. The method further includes receiving, by the access node, a second TLV from a second gateway, where the second TLV includes the CMAC address, the IP address, and the L2 I-SID. The method further includes, in response to determining that the L2 I-SID exists in an LSDB of the access node, determining that the first gateway is closer to the access node than the second gateway. The method also includes storing the CMAC address in a database to point to the first gateway based on the determination.

### BACKGROUND

### Field

The described aspects generally relate to an anycast gateway. For example, some aspects of this disclosure relate to the anycast gateway for Intermediate System to Intermediate System (ISIS) Shortest Path Bridging (SPB)-Media Access Control (MAC) (SPBM).

### Related Art

Gateway redundancy protocols, like Virtual Router Redundancy Protocol (VRRP), applied to an SPB network do not provide true anycast gateway functionality. For example, if multiple gateways are used for redundancy purposes in the SPB network, during the operation of the gateways, one gateway becomes the primary gateway for the SPB network and the other gateways are not used. In these examples, the network devices (e.g., switches, access nodes, and the like) in the SPB network only use the primary gateway for communicating with device inside and/or outside of the SPB network even if the path cost to reach the primary gateway is higher than the path costs of other gateways of the SPB network.

### SUMMARY

Some aspects of this disclosure include apparatuses and methods for implementing anycast gateways, and more specifically, anycast gateways for Intermediate System to Intermediate System (ISIS) Shortest Path Bridging (SPB)-Media Access Control (MAC) (SPBM).

Some aspects of this disclosure relate to a method for using gateways in a Shortest Path Bridging (SPB) network. The method includes receiving, by an access node, a first Type-Length-Value (TLV) from a first gateway. The first TLV includes a Client Media Access Control (CMAC) address for the first gateway, an Internet Protocol (IP) address of the first gateway, and a layer 2 (L2) Instance Service Identifiers (I-SID) associated with the first gateway. The method further includes receiving, by the access node, a second TLV from a second gateway, where the second TLV includes the CMAC address, the IP address, and the L2 I-SID. The method further includes, in response to determining that the L2 I-SID exists in Link State Databases (LSDB) of the access node, determining that the first gateway is closer to the access node than the second gateway. The method also includes storing the CMAC address in a database to point to the first gateway based on the determination.

In some aspects, the first gateway has a first priority for forwarding the packet and the second gateway has a second priority for forwarding the packet, and the method further includes determining that the first gateway is unavailable and updating the database such that the CMAC address points to the second gateway as the first priority for forwarding the packet.

In some aspects, the method further includes receiving a third TLV from a third gateway, where the third TLV includes the CMAC address, the IP address, and the L2 I-SID. The method further includes determining that the third gateway is closer to the access node than the first and second gateways and updating the database such that the CMAC address points to the third gateway as the first priority for forwarding the packet.

In some aspects, the method further includes determining a first cost metric associated with the first gateway, determining a second cost metric associated with the second gateway, and in response to the second cost metric being greater than the first cost metric, determining that the first gateway is closer to the access node than the second gateway.

In some aspects, the first TLV further includes a first cost value and the second TLV further includes a second cost value. Determining the first cost metric can include determining a first combination of the first cost value and a cost value of a first link between the access node and the first gateway. Determining the second cost metric can include determining a second combination of the second cost value and a cost value of a second link between the access node and the second gateway.

In some aspects, the first gateway and the access node are located in a first network area in a multi-area network and the second gateway is located in a second network area of the multi-area network. The second network area is different from the first network area.

Some aspects of this disclosure relate to an access node that includes a memory and at least one processor coupled to the memory. The at least one processor is configured to receive a first Type-Length-Value (TLV) from a first gateway. The first TLV includes a Client Media Access Control (CMAC) address for the first gateway, an Internet Protocol (IP) address of the first gateway, and a layer 2 (L2) Instance Service Identifiers (I-SID) associated with the first gateway. The at least one processor is further configured to receive a second TLV from a second gateway, where the second TLV includes the CMAC address, the IP address, and the L2 I-SID. The at least one processor is further configured to determine that the first gateway is closer to the access node than the second gateway, in response to determining that the L2 I-SID exists in Link State Databases (LSDB) of the access node. The at least one processor is further configured to store the CMAC address in a database to point to the first gateway based on the determination.

Some aspects of this disclosure relate to a non-transitory computer-readable device having instructions stored thereon. When the instructions are executed by at least one processor of an access node, cause the at least one processor to perform operations including receiving a first Type-Length-Value (TLV) from a first gateway. The first TLV includes a Client Media Access Control (CMAC) address for the first gateway, an Internet Protocol (IP) address of the first gateway, and a layer 2 (L2) Instance Service Identifiers (I-SID) associated with the first gateway. The operations further include receiving a second TLV from a second gateway, where the second TLV includes the CMAC address, the IP address, and the L2 I-SID. The operations further include, in response to determining that the L2 I-SID exists in Link State Databases (LSDB) of the access node, determining that the first gateway is closer to the access node than the second gateway. The operations also include storing the CMAC address in a database to point to the first gateway based on the determination.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE DRAWINGS

The accompanying drawings are incorporated herein and form a part of the specification.

FIG. 1A illustrates an exemplary system that implements the anycast gateways, according to some aspects of this disclosure.

FIG. 1B illustrates another exemplary system that implements the anycast gateways within a multi-area network, according to some aspects of this disclosure.

FIG. 2 is a flowchart illustrating example operations for implementing and applying the anycast gateways, according to some aspects of this disclosure.

FIG. 3 is an example computer system for implementing various aspects.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Provided herein are system, apparatus, device, method and/or computer program product aspects, and/or combinations and sub-combinations thereof, for implementing anycast gateways, and more specifically, for anycast gateways for ISIS SPBM networks.

Gateway redundancy protocols applied to an SPB network do not provide true anycast gateway functionality. For example, if multiple gateways are used for redundancy purposes in the SPB network, during the operation of the gateways, one gateway becomes the primary gateway for the SPB network and the other gateways are not used. In these examples, the network devices (e.g., switches, access nodes, and the like) in the SPB network only use the primary gateway for communicating with devices inside and/or outside of the SPB network even if the path cost to reach the primary gateway is higher than the path costs of other gateways of the SPB network.

For example, the VRRP applied to the SPB network elects a single master gateway (also referred herein as router too); and the VRRP Hello protocol results in all SBP switches pointing the VRRP Client (or Customer) MAC address (CMAC address) towards the SPB switch Backbone MAC (BMAC) that is the master gateway, even if the path cost to reach this master gateway is higher than other VRRP gateways (e.g., other gateways in a backup state). This creates sub-optimal Internet Protocol (IP) routed paths with higher than expected path latency. The VRRP is also a “chatty” protocol, which requires the VRRP master gateway to emit VRRP Hellos every few seconds across each and every Layer 2 (L2) segment where VRRP was enabled.

Other SPB features such as the Distributed Virtual Routing (DVR) work by defining the IP gateway on selected DVR controller core switches and letting these push the gateway's routed CMAC address out to participating DVR Leaf access nodes within a pre-defined DVR Domain. The DVR is mostly designed to provide host-based IP routing directly on the DVR Leaf access nodes, which brings a number of constraints and limitations on the participating DVR Leaf access nodes that ultimately make it less useful in Campus SBP deployments.

The anycast gateway for the SPB networks as disclosed herein addresses the above problems by providing a mechanism that delivers anycast gateway across any part of the SPB network, where all anycast gateways are actively forwarding traffic for the L2 segment, with other SPB switches, while still operating at L2 only, are able to forward traffic destined for the gateway CMAC address only to the nearest available anycast gateway, without any of the constraints of the DVR functionality.

As discussed in more detail, the anycast gateway for the SPB network can leverage SPB's shortest path into selection of nearest anycast gateway by any other SPB switch in the network. Additionally, or alternatively, the anycast gateway for the SPB network can leverage SPB ISIS's Link State Databases (LSDB) to propagate and validate the anycast gateway configuration across many core nodes. Additionally, or alternatively, the anycast gateway for the SPB network may not need any additional control plane messaging besides SPB's native ISIS implementation and the addition of a new ISIS Type-Length-Value (TLV).

According to some aspects, the anycast gateway for ISIS SPBM can be a method of providing resilient IPv4 and IPV6 default gateway for L2 Instance Service Identifiers (I-SID) segments leveraging SPB's shortest path so as to ensure that an access node will always use the nearest available gateway for the given I-SID segment.

According to some aspects, and as discussed in more detail below, core switches in the SPB network, where the anycast gateway IP interface is defined, can emit a new ISIS anycast gateway TLV, which specifies the gateway's CMAC address and/or Virtual Router ID (VRID) as well as IP, Mask, Layer 3 (L3) Internet Protocol Virtual Private Network (IPVPN) context, cost metric, and/or I-SID context.

According to some aspects, the information in the anycast gateway TLV can have at least two purposes. Firstly, the information in the anycast gateway TLV can allow the gateways themselves to validate and verify the validity of the gateway IP, CMAC address and/or L3 IPVPN context configured for the given I-SID context, and to alert the administrator in case an inconsistent configuration was applied on the different anycast gateways. Secondly, access nodes (e.g., SPB switches such as Backbone Edge Bridges (BEBs)), where an I-SID segment is defined, can inspect the ISIS LSDB for anycast gateway TLVs containing a definition for the same I-SID. If these are found, the one from the nearest advertising gateway is retained; and the gateway's CMAC address (obtained from the TLV) is programmed in the L2 I-SID forwarding information base (FIB) (e.g., a MAC table) pointing to that nearest advertising core BMAC address. To calculate the nearest advertising gateway, the sum of the SPB path metric to reach the access node advertising the TLV is added to any non-zero cost metric found within the new TLV's I-SID data. According to some aspects, in the event of equal cost, the TLV selection will ensure that both gateways get selected across different I-SID segments.

According to some aspects, by using the anycast gateway of this disclosure, there is thus no longer any need for the access nodes to learn the anycast gateway's CMAC address from SPB traffic being MAC-in-MAC de-capsulated. According to some aspects, the anycast gateway for ISIS SPBM does not make use of any additional control plane messaging protocol data units (PDUs) other than standard SPB ISIS for communication between anycast gateways and other BEBs or for communication between anycast gateways and other anycast gateways.

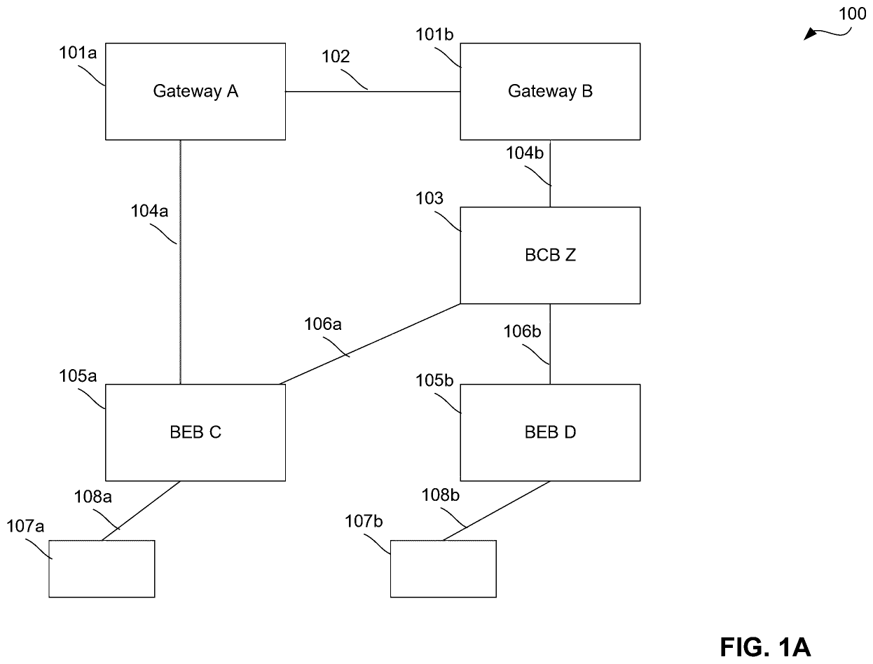

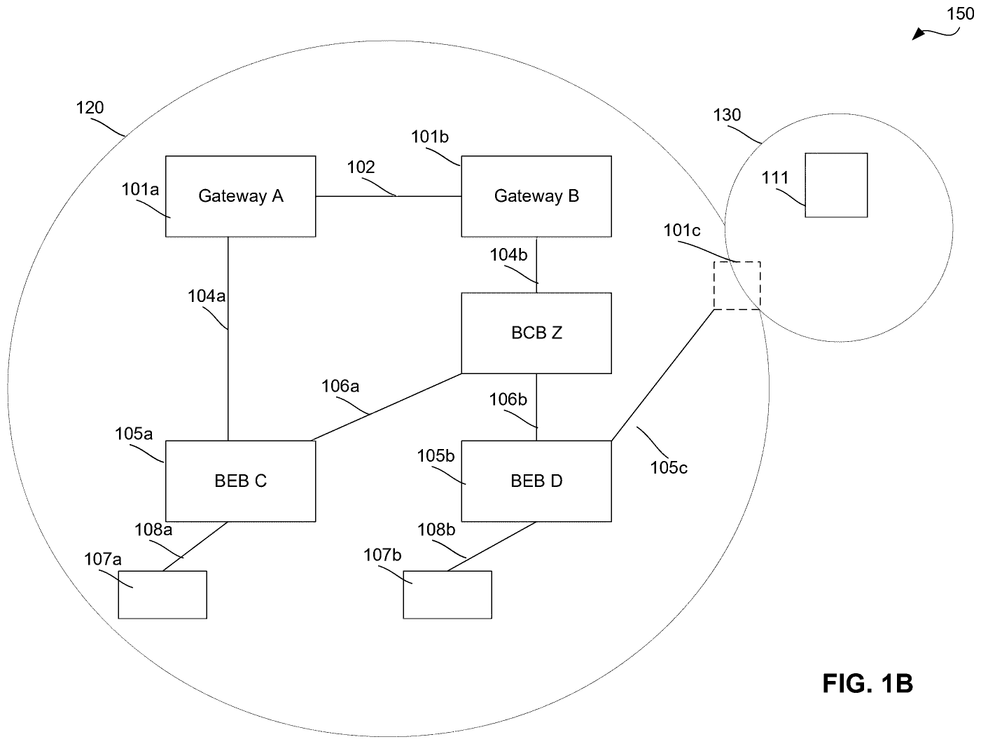

FIG. 1A illustrates an exemplary system that implements the anycast gateways, according to some aspects of this disclosure.

Network 100 (e.g., an SPB network) can include one or more gateways 101. For example, network 100 can include gateway A 101a and gateway B 101b (referred to as “gateway 101” or collectively as “gateways 101”). According to some aspects, gateways 101 can be routers that communicate with devices inside and/or outside of network 100. For example, gateways 101 can be routers that communicate with devices on other IP networks inside the network 100. Additionally, or alternatively, gateways 101 can be routers that communicate with devices outside of network 100. Gateways 101 can be referred to herein as “anycast gateways” too. Although two gateways 101 are illustrated in FIG. 1, the aspects of this disclosure are not limited to this example and network 100 can include any number of gateways 101.

Network 100 can also include other network devices in addition to gateways 101. For example, network 100 can include one or more network devices 103. In some aspects, network device 103 can include a backbone core bridge (BCB).

Network 100 can also include access nodes 105. For example, network 100 can include access node 105a and access node 105b (referred to as “access node 105” or collectively as “access nodes 105”). According to some aspects, access nodes 105 can be backbone edge bridges (BEBs). For example, access nodes 105 can be non-gateway BEBs. Although two access nodes 105 are illustrated in FIG. 1, the aspects of this disclosure are not limited to this example and network 100 can include any number of access nodes 105.

According to some aspects, each access node 105 can be coupled to one or more end stations 107 (referred to as “end station 107” or collectively as “end stations 107”). For example, access node 105a can be coupled to end station 107a using link (or path) 108a. Similarly, access node 105b can be coupled to end station 107b using link (or path) 108b. End stations 107 can be part of network 100. Additionally, or alternatively, end stations 107 are not part of network 100 but are coupled to network 100 using access nodes 105.

According to some aspects, gateway 101a and gateway 101b are both active and leverage shortest path methods of SPB for each respective one of gateway 101a and gateway 101b for forwarding traffic through network 100. Network 100 allows for multiple active gateways (gateway 101a and gateway 101b) for redundancy purposes and also for leveraging shortest path solutions for multiple gateways. As discussed in more detail below, and as one non-limiting example, access node 105a can be “closer” to gateway 101a and therefore, access node 105a can communicate with gateway 101a. Similarly, access node 105b can be “closer” to gateway 101b and therefore, access node 105b can communicate with gateway 101b. According to some aspects, network 100 does not put any restrictions on access nodes 105 and allows access nodes 105 to be L2 nodes.

According to some aspects, network 100 runs SPB, and the control plane is link state, which is ISIS. Gateways 101 (also referred to herein as “anycast gateways”) are configured to generate and advertise a TLV to practice the features of this disclosure.

According to some aspects, gateways 101 have the same IP address and the same CMAC address. In some aspects, gateways 101 can have different BMAC addresses. In a non-limiting example (provided for illustration only), gateway A 101a can have a BMAC address of AA.AA.AA.AA.AA.AA.1 GW 00:00:00:11:22:33 GW CMAC. In this non-limiting example (provided for illustration only), gateway B 101b can have a BMAC address of BB.BB.BB.BB.BB.BB.1 GW 00:00:00:11:22:33 GW CMAC.

Each of gateways 101 can generate and advertise its TLV throughout network 100. According to some aspects, each of gateways 101 transmits one or more packets that include the TLV(s) to advertise their TLV. For example, gateway 101a can generate and advertise a first TLV throughout network 100. For example, gateway 101b can generate and advertise a second TLV throughout network 100. The TLV generated and advertised by gateway 101a (e.g., the first TLV) can include information such as, but not limited to, the CMAC address of gateway 101a, an L2 I-SID associated with gateway 101a, an L3 IPVPN associated with gateway 101a, IP address of gateway 101a, a netmask of gateway 101a, and/or a cost value associated with gateway 101a. The TLV generated and advertised by gateway 101b (e.g., the second TLV) can include information such as, but not limited to, the CMAC address of gateway 101b, an L2 I-SID associated with gateway 101b, an L3 IPVPN associated with gateway 101b, IP address of gateway 101b, a netmask of gateway 101b, and/or a cost value associated with gateway 101b. The IP version can be 4 or 6, per network entry in the TLV.

The aspects of this disclosure are not limited to these examples, and the TLVs generated and advertised by gateways 101 can include additional information. Additionally, or alternatively, the TLVs generated and advertised by gateways 101 can include a subset of the information provided above. In some examples, instead of (or in addition to) CMAC address, the VRID of the gateway can be used. The TLV generated and advertised by gateways 101 are also referred herein as anycast gateway TLV.

According to some aspects, the anycast gateway TLVs can be used for validating and verifying the anycast gateways. For example, gateway A 101a receives a TLV (e.g., the second TLV) from gateway B 101b. Gateway A 101a can inspect and analyze the information in the second TLV to verify and validate gateway B 101b. For example, gateway A 101a can verify and validate one or more of the CMAC address of gateway 101a, an L2 I-SID associated with gateway 101a, an L3 IPVPN associated with gateway 101a, IP address of gateway 101a, a netmask of gateway 101a, and/or a cost value associated with gateway 101a. If one or more these attributes of the second TLV are not consistent with the L2 I-SID of gateway A 101a, then gateway 101a can determine that the second TLV is not valid. For example, if one or more the attributes of the second TLV are not configured for the L2 I-SID of gateway A 101a, then gateway 101a can determine that the second TLV is not valid. According to some aspects, gateway A 101a can use other methods to determine if the second TLV from gateway B 101b includes any inconsistencies.

For example, gateway A 101a can compare the information of the second TLV received from gateway B 101b with the corresponding information of the first TLV of gateway A 101a to determine any inconsistencies. In some aspects, gateways 101 on the same network 100 have the same IP address, the same CMAC address, the same netmask, the same L2 I-SID, and/or the same L3 IPVPN.

In response to determining invalidity and/or inconsistency, gateway A 101a can then alert an administrator of network 101 that the TLV from gateway B 101b is not valid. Additionally, or alternatively, gateway A 101a can generate a report based on the invalidity and/or inconsistency to send to the administrator and/or to network 100.

In addition to, or alternatively to, using the anycast gateway TLVs for validating and verifying the anycast gateways, the anycast gateway TLVs can be used by the access nodes 105 for determining the “closest” anycast gateway from the anycast gateways for forwarding traffic.

According to some aspects, access node 105a receives the first TLV from gateway A 101a. Access node 105a can receive the first TLV associated with gateway A 101a from any other neighboring switch(es). Also, access node 105b receives the second TLV from gateway B 101b. Access node 105b can receive the second TLV associated with gateway B 101b from any other neighboring switch(es) (e.g., network device 103). According to some aspects, access node 105a is configured to examine the L2 I-SID information of the first TLV. If access node 105a is configured as an L2 segment for the same L2-SID of the first TLV, then access node 105a can store information associated with the first TLV in a database of access node 105a. In some aspects, access node 105a is configured as the L2 segment for the same L2-SID if one or more end stations 107a coupled to access node 105a are the L2 segment for the same L2-SID. The L2 presence can be dynamic. Access node 105a can compare the L2 I-SID of the first TLV with its L2 I-SID retrieved from the LSDB of access node 105a. If access node 105a is not configured as the L2 segment for the same L2-SID of the first TLV, then access node 105a can ignore the first TLV.

Similarly, access node 105a is configured to examine the L2 I-SID information of the second TLV. If access node 105a is configured as an L2 segment for the same L2-SID of the second TLV, then access node 105a can store information associated with the second TLV in a database of access node 105a. In some aspects, access node 105a is configured as the L2 segment for the same L2-SID if one or more end stations 107a coupled to access node 105a are the L2 segment for the same L2-SID. Access node 105a can compare the L2 I-SID of the second TLV with its L2 I-SID retrieved from the LSDB of access node 105a. If access node 105a is not configured as the L2 segment for the same L2-SID of the second TLV, then access node 105a can ignore the second TLV.

According to some aspects, gateways 101, network device 103, and/or access nodes 105 are part of the same SPB fabric and have the same copy of the LSDB.

According to some aspects, the database associated with access node 105a (used for, for example, storing the information of the first TLV and/or the second TLV), can include an L2 I-SID FIB (such as a MAC table).

According to some aspects, when access node 105a determines that the first TLV has the same L2 I-SID as the L2 I-SID of access node 105a, access node 105a can store the CMAC address from the first TLV in the database (e.g., the L2 I-SID FIB (such as a MAC table)) of access node 105a if gateway A 101a is the “closest” gateway to access node 105a. Access node 105a can further point the stored CMAC address to the BMAC address of gateway A 101a that transmitted the first TLV. For example, the database (e.g., the L2 I-SID FIB (such as a MAC table)) can include a mapping between the CMAC address from the first TLV and the BMAC address of gateway A 101a. Access node 105a can store other information of the first TLV in the database (e.g., the L2 I-SID FIB (such as a MAC table)).

According to some aspects, when access node 105a determines that the second TLV has the same L2 I-SID as the L2 I-SID of access node 105a, access node 105a can store the CMAC address from the second TLV in the database (e.g., the L2 I-SID FIB (such as a MAC table)) of access node 105a if gateway B 101b is the “closest” gateway to access node 105a. Access node 105a can further point the stored CMAC address to the BMAC address of gateway B 101b that transmitted the second TLV. For example, the database (e.g., the L2 I-SID FIB (such as a MAC table)) can include a mapping between the CMAC address from the second TLV and the BMAC address of gateway B 101b. Access node 105a can store other information of the second TLV in the database (e.g., the L2 I-SID FIB (such as a MAC table)).

Access node 105a is configured to determine a cost metric for each of the gateways 101 to determine which gateway 101 is “closer” to access node 105a. According to some aspects, the cost metric and the “closeness” is determined based on the SPB protocol used by network 100.

For example, link (or path) 104a between access node 105a and gateway A 101a can have a first cost metric. The first cost metric can be based on a quality metric (e.g., the speed) of link 104a. Similarly, the links between access node 105a and gateway B 101b (e.g., combination of links 106a and 104b) can have a second cost metric. The second cost metric can be based on a quality metric (e.g., the speed) of links 106a and 104b. However, the aspects of this disclosure are not limited to these examples, and other SPB and/or ISIS information can be used for determining the first cost metric and/or the second cost metric. In some examples, the cost metric (and/or a shortest path) can be a user-defined metric (and/or a user-defined path).

According to some aspects, access node 105a can determine the first cost metric and/or the second cost metric once network 100 is established. Additionally, or alternatively, access node 105a can periodically determine the first cost metric and/or the second cost metric. Additionally, or alternatively, access node 105a can determine the first cost metric and/or the second cost metric when there are changes in network 100. Additionally, or alternatively, access node 105a can access a database (e.g., the LSDB) that stores the first cost metric and/or the second cost metric.

According to some aspects, access node 105a stores the information of the first TLV and/or the second TLV in the database and points the information to corresponding BMAC address(es) based on the determined (and/or retrieved) first cost metric and/or second cost metric. For example, if the first cost metric (that is associated with gateway A 101a) is less than the second cost metric (that is associated with gateway B 101b), access node 105a determines that gateway A 101a is “closer” to access node 105a than gateway B 101b. Therefore, access node 105a stores the information of the first TLV and points the information to the BMAC address of gateway A 101a with the highest priority in the database (e.g., the L2 I-SID FIB (such as a MAC table)). Access node 105a stores the information of the second TLV (and optionally points the information to the BMAC address of gateway B 101b) with the lower priority in, for example, the LSDB.

Therefore, the database (e.g., the L2 I-SID FIB (such as a MAC table)) stores the information for the first TLV and points the information to the BMAC address of gateway A 101a with the highest priority (e.g., the “closest” gateway). So, access node 105a knows which gateway 101 is “closer” based on the priority of the stored information. The LSDB (or other databases) can store the information for both TLVs and can point to BMAC addresses of both gateways 101. Additionally, or alternatively, the LSDB (or other databases) can store the information for second TLV and can point to BMAC addresses of gateway B 101b (e.g., the lower priority gateway). In other words, the database (e.g., the L2 I-SID FIB (such as a MAC table)) of access node 105a can store the information for the TLV of the “closest” gateway and can point the information to the BMAC address of the closest gateway. The LSDB (as one exemplary database) of access node 105a can store the information for other TLVs of other gateways and can point the information to the BMAC addresses of the other gateways. The LSDB (as one exemplary database) of access node 105a can store the priority of the other gateways based on their distance (e.g., “closeness”) to access node 105a. According to some aspects, and in the event of equal cost metrics, both gateways 101 can get selected across different I-SID segments.

According to some aspects, access node 105a is configured to update the LSDB and/or the database (e.g., the L2 I-SID FIB (such as a MAC table)) based on any changes in network 100. For example, if the cost metrics of links (e.g., paths) change, access node 105a can update the LSDB and/or the database (e.g., the L2 I-SID FIB (such as a MAC table)) accordingly. As another example, if one of gateways 101 becomes unavailable, access node 105a can update the LSDB and/or the database (e.g., the L2 I-SID FIB (such as a MAC table)) accordingly. As another example, if a new gateway 101 is added to network 100, access node 105a can update the database (e.g., the L2 I-SID FIB (such as a MAC table)) accordingly.

As another non-limiting example, and from the point of view of access node 105b, access node 105b can receive the first TLV from gateway A 101a and the second TLV from gateway B 101b. Access node 105b can use its LSDB to determine that the first TLV and/or the second TLV have the same L2 I-SID as access node 105b. In response to the determination, access node 105 can store the information of the first TLV or the second TLV in its database (e.g., the L2 I-SID FIB (such as a MAC table)) and can point the information to corresponding BMAC address of gateway A 101a or gateway B 101b, respectively. Access node 105b can determine that the cost metric associated with gateway A 101a (e.g., the cost metric of links 104a, 106a, and 106b) is more than the cost metric associated with gateway B 101b (e.g., the cost metric of links 104b and 106b). Therefore, access node 105b stores the information of the second TLV and points the information to the BMAC address of gateway B 101b with the highest priority in its database (e.g., the L2 I-SID FIB (such as a MAC table)). Access node 105b also stores the information of the first TLV (and optionally points the information to the BMAC address of gateway A 101a with the lower priority in its, for example, LSDB, indicating the lower priority of gateway A 101a.

Therefore, access nodes 105 (and/or end stations 107) will use the closest gateway 101 as the default gateway based on the SPBM shortest path for forwarding their traffic. For example, access node 105a (and/or end station 107a) will use the gateway 101a as the default gateway and access node 105b (and/or end station 107a) will use the gateway 101b as the default gateway. According to some aspects, there is thus no longer any need for access nodes 105 to learn the CMAC addresses of gateways 101 from SPB traffic being MAC-in-MAC de-capsulated. According to some aspects, gateways 101 do not make use of any additional control plane messaging PDUs other than standard SPB ISIS.

According to some aspects, access node 105a can have (or have access to) its database (e.g., the L2 I-SID FIB (such as a MAC table)) that stores the TLV information. Based on its database (e.g., the L2 I-SID FIB (such as a MAC table)), access node 105a knows to use gateway A 101a for forwarding traffic from and/or to end station 107a. Access node 105 knows to use gateway A 101a because the TLV information stored as the highest priority points to the BMAC address of gateway A 101a. If gateway A 101a becomes unavailable, access node 105a can use the gateway whose information is stored as the second highest priority in, for example, the LSDB of access node 105a. In this example, when access node 105a determines that gateway A 101a is unavailable, access node 105a uses gateway B 101b because the TLV information stored as the second highest priority points to the BMAC address of gateway B 101b. In some aspects, access node 105a moves the TLV information associated with gateway B 101b from the LSDB to the database (e.g., the L2 I-SID FIB (such as a MAC table)), where the TLV information associated with gateway B 101b points to the BMAC address of gateway B 101b. In other words, access node 105a replaces the TLV information associated with gateway A 101a with the TLV information associated with gateway B 101b in the second database (e.g., the L2 I-SID FIB (such as a MAC table)). In some aspects, access node 105a can determine that gateway A 101a is unavailable based on updated LSBD. Access node 105a can use other methods to determine that gateway A 101a is unavailable.

According to some aspects, gateway A 101a has its own unique IP address and a virtual IP address. Gateway B 101b also has its own unique IP address and the same virtual IP address as gateway A 101a. Therefore, if network 101 has N gateways 101, then N+1 IP addresses are used for gateways 101 (N IP addresses for the N gateways 101 and 1 virtual IP address). In some aspects, gateway A 101a and gateway B 101b have the same IP address. Therefore, if network 101 has N gateways 101, then a single IP address is used for gateways 101.

According to some aspects, client devices (e.g., end stations 107) configured with an IP default gateway to match, for example, the IP of gateway A 101a, will use Address Resolution Protocol (ARP) requests/response for their default gateway IP. All gateways 101 will respond to these ARP requests, by providing the gateway's CMAC address in the ARP Sender MAC field. These ARP responses will also use the CMAC address of the gateways 101 in the ARP Response Ethernet source MAC field, which will thus also ensure that any L2 switches external to network 100 and connected to an access point 105 over which the I-SID is mapped to a regular VLAN will be able to correctly learn the CMAC of gateways 101 in their respective MAC tables.

In a non-limiting example, end station 107a can send an APR request over link 108a to access node 105a. According to some aspects, access node 105a can send the APR request to both gateway A 101a and gateway B 101b. Both gateway A 101a and gateway B 101b respond to the APR request using, for example, an APR response. The APR response from gateway A 101a can use the CMAC address of gateway A 101a. The APR response from gateway B 101b can use the CMAC address of gateway B 101b. According to some aspects, after receiving both APR responses, access node 105a sends the response from gateway A 101a to end station 107a. In some aspects, access node 105a sends the response from gateway A 101a to end station 107a because the CMAC in the APR response points to gateway A 101a as indicated in the database (e.g., the L2 I-SID FIB (such as a MAC table)) of access node 105a. Access node 105a can ignore the ARP response from gateway B 101b because the CMAC in the APR response does not point to gateway B 101b.

According to some aspects, end stations 107 can be silent nodes (e.g., printers) that do not send requests to gateways 101. But end station 107a (as an example) can receive a request. For example, gateway A 101a can receive a print job request from outside of network 101 to send to end station 107a. Gateway A 101 can send an ARP request and can use its own CMAC address and puts a null IP address in the ARP request. In this way, when end station 107a receives the ARP request and responds to it, the response goes back to the gateway A 101a that needs to receive it. In other words, access node 105a sends the response from end station 107a to gateway A 101a because the CMAC in the ARP response points to gateway A 101a as indicated in the database (e.g., the L2 I-SID FIB (such as a MAC table)) of access node 105a.

For example, when traffic is initiated from gateway A 101a, gateway A 101a will send ARP requests for the clients IP using an ARP broadcast where the Ethernet source MAC and ARP Sender MAC is set to the CMAC address of gateway A 101a for the I-SID interface and the ARP Sender IP is set to 0.0.0.0. This ensures that any ARP response will come back to the same gateway A 101a that generated the ARP request. This can enable each gateway 101 to build a complete ARP table without unique IP addresses.

FIG. 1B illustrates another exemplary system that implements the anycast gateways within a multi-area network, according to some aspects of this disclosure.

According to some aspects, multi-area network 150 can include one or more networks 120 and 130 (also referred to herein as “network areas”). Although two networks are shown, multi-area neatwork 150 can include any number of networks. According to some aspects, network 120 is similar to (or the same as) network 100 of FIG. 1A and the same systems/devices are shown with the same numerals. Network 130 can include one more network devices, such as access nodes, gateways, or the like. Although only a gateway 111 is illustrated, network 130 can include any number of network devices. Some non-limiting examples of network devices in networks 100, 120, and/130 can include computers, routers, gateways, modems, printers, scanners, TVs, smart phones, Internet of Things (IoT) devices, bridges, switches, and the like.

Multi-area network 150 can be a multi-area SPB fabric that implements the anycast gateways of this disclosure. The anycast gateways for ISIS SPBM of this disclosure can also be defined to work from the start in multi-area SPB fabrics, where gateways that have been configured with an anycast gateway IP, can be located in different ISIS areas, provided that the I-SID is redistributed between those areas.

In some aspects, a SPB network is segmented into multiple areas and these areas are connected hierarchically or in any loop free flexible topology. Each area in the multi-area SPB fabric can be self-contained such that network changes in one area is not visible in other areas. For example, each network area does not have access to the LSBD of the other network areas.

According to some aspects, network 120 of multi-area network 150 can include a virtual gateway 101c. Virtual gateway 101c is configured to represent network 130 in network 120. In some aspects, one or more boundary nodes located at the boundary of networks 120 and 130 (not shown) can be configured to implement virtual gateway 101c.

As discussed above, the TLV transmitted (e.g., advertised) by gateways 101 (e.g., gateway A 101a, gateway B 101b, and gateway 101c) can include a cost value associated with the gateway. According to some aspects, the cost value can indicate whether the gateway is in the same network (e.g., the same network area) as the access node that receives the TLV.

For example, gateway 111 of network 130 can transmit a TLV that is received at virtual gateway 101c. Additionally, or alternatively, virtual gateway 101c receives the TLV of gateway 111 through other methods. Virtual gateway 101c can update the TLV to add or update the cost value in the TLV. Virtual gateway 101c can transmit the updated TLV such that access nodes 105 receive the updated TLV. Without the updated cost value in the updated TLV, access nodes 105 may assume that the updated TLV has come from a gateway in network 120 and not from a gateway outside of network 120 (e.g., from network 130). Therefore, without the updated cost value in the updated TLV, access nodes 105, access node may miscalculate how close gateway 111 is because access nodes 105 do not have access to the LSBD of network 130.

According to some aspects, the cost value in the TLV from gateway 111 and/or the updated cost value in the updated TLV from virtual gateway 101c can be the cost of communicating from the edge of network 120 to gateway 111

According to some aspects, gateways 101a and 101b can set the cost value of their TLV to a zero value. For example, gateways 101a and 101b can set the cost value of their TLV to a zero value for the TLVs they send within network 120. According to some aspects, virtual gateway 101c can set the cost value of TLVs that virtual gateway 101c receives from other networks (other than network 120) to a non-zero value. The non-zero value can indicate the cost of communication between virtual gateway 101c and a specific gateway in the other network.

According to some aspects, the anycast gateways for ISIS SPBM can ensure that Campus client to server (e.g., South to North) traffic will always take the shortest path across the network, even for IP routed flows. To provide the same shortest path in the reverse (e.g., North to South), a mechanism is also defined to let the anycast gateways (and/or their associated network devices) learn the client host IPs by matching their ARP records with the SPB path metric to reach the SPB switch where the anycast gateways (and/or their associated network devices) are located. This allows the anycast gateways (and/or their associated network devices) to selectively feed these host IP routes with their calculated metric into whatever IP routing protocol is being used in the wider network, including, but not limited to, ISIS itself, Open Shortest Path First (OSPF), and/or Border Gateway Protocol (BGP).

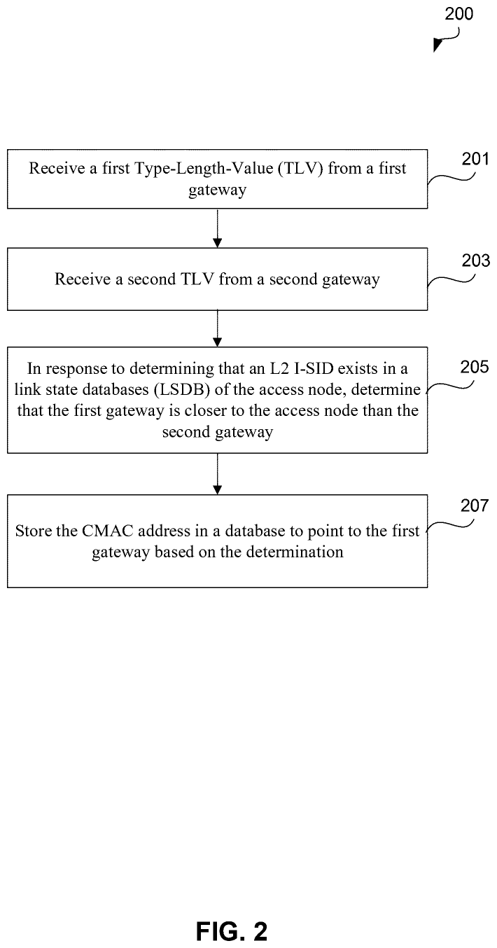

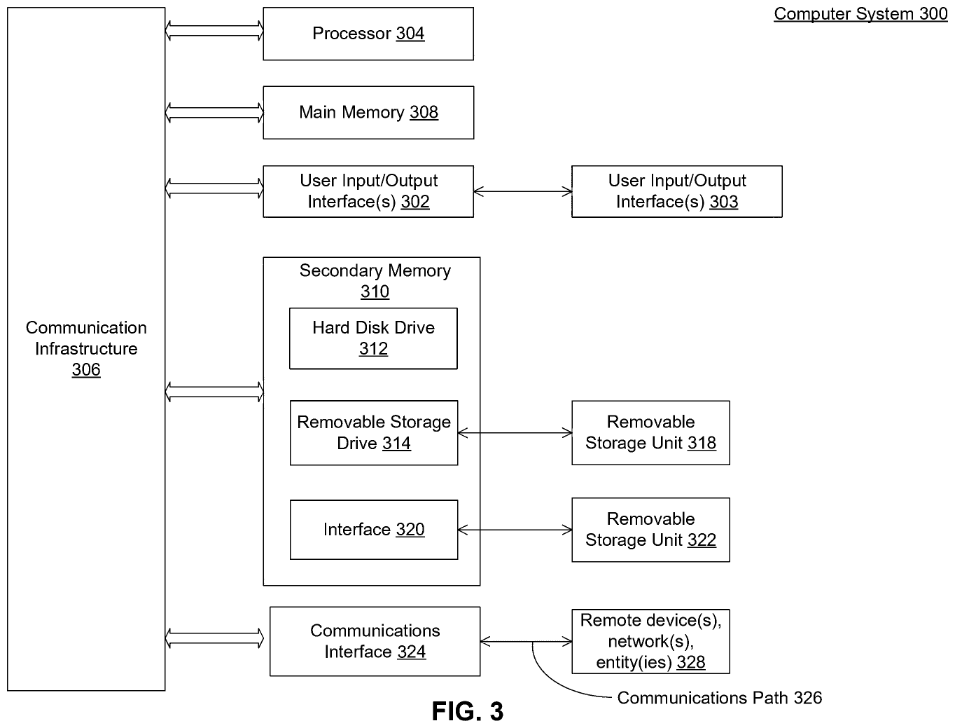

FIG. 2 illustrates an example method 200 for implementing and applying the anycast gateways, according to some aspects of this disclosure. As a convenience and not a limitation, FIG. 2 may be described with regard to elements of FIGS. 1A and 1B. Method 200 may represent the operation of a system (e.g., access nodes 105). Method 200 may also be performed by computer system 300 of FIG. 3. But method 200 is not limited to the specific aspects depicted in those figures and other systems may be used to perform the method as will be understood by those skilled in the art. It is to be appreciated that not all operations may be needed, and the operations may not be performed in the same order as shown in FIG. 2.

At 201, a first Type-Length-Value (TLV) is received from a first gateway. For example, an access node (e.g., access node 105b of FIG. 1A) receives a first TLV from the first gateway (e.g., gateway A 101a of FIG. 1A). The access node can receive the first TLV associated with the first gateway from any other neighboring switch(es) (e.g., network device 103). According to some aspects, the first TLV includes a Client Media Access Control (CMAC) address for the first gateway, an Internet Protocol (IP) address of the first gateway, and a layer 2 (L2) Instance Service Identifiers (I-SID) associated with the first gateway.

At 203, a second TLV is received from a second gateway. For example, the access node (e.g., access node 105b) receives the second TLV from the second gateway (e.g., gateway B 101b of FIG. 1A). The access node can receive the second TLV associated with the second gateway from any other neighboring switch(es) (e.g., network device 103). According to some aspects the second TLV also includes the same CMAC address as in the first TLV, the same IP address as in the first TLV, and the same L2 I-SID as in the first TLV. In other words, first TLV and the second TLV can include the same CMAC address, the same IP address, and the same L2 I-SID.

According to some aspects, method 200 can further include comparing the L2 I-SID of the first and second TLVs with an L2 I-SID in Link State Databases (LSDB) of the access node. The access node can use its LSDB to determine that the first TLV and/or the second TLV have the same L2 I-SID as the access node.

At 205, it is determined whether the first gateway is closer to the access node than the second gateway in response to determining that the L2 I-SID of the first and second TLVs exists in the LSDB of the access node. In other words, when the access node determines that L2 I-SID of the first and second TLVs are the same as the access node's L2 I-SID, the access node can determine which one the first gateway or the second gateway is closer to the access node.

According to some aspects, the access node can use cost metrics associated with the gateways to determine which gateway is closer to the access node. According to some aspects, operation 205 can include determining a first cost metric associated with the first gateway, determining a second cost metric associated with the second gateway, and comparing the first cost metric with the second cost metric. In response to the first cost metric and the second cost metric satisfying a condition, the access node can determine which one the first gateway and the second gateway are closer to the access node. For example, in response to the second cost metric being greater than the first cost metric, the access node determines that the first gateway is closer to the access node than the second gateway.

According to some aspects, and in order to take into consideration if any of the first TLV or the second TLV may have been received from a network area in a multi-area network outside of the a network area of the access node, the access node can examine and/or use a cost value in the first or second TLV. For example, the first TLV can further include a first cost value and the second TLV can further include a second cost value. In order to determine the first cost metric, the access node can determine a first combination of the first cost value and a cost value of a first link between the access node and the first gateway. Similarly, to determine the second cost metric, the access node can determine a second combination of the second cost value and a cost value of a second link between the access node and the second gateway.

At 207, the CMAC address is stored in a database to point to the first gateway based on the determination of 205. For example, when the access node determines that first gateway is closer to the access node than the second gateway, the access node stores the CMAC address in the database to point to the first gateway. The database can include, but is not limited to a forwarding information base (FIB) (e.g., a MAC table). According to some aspects, the database will include a mapping between the CMAC address and a BMAC address of the first gateway.

According to some aspects, in addition to storing the CMAC address in the database to point to the first gateway (e.g., to point to the BMAC address of the first gateway), the access node can store information associated with the second gateway (e.g., the CMAC address of the second gateway) in another database (e.g., an LSDB) with an indication of lower priority compared to the first gateway. For example, the access node can store the CMAC address of the second gateway in the other database (e.g., the LSDB) to point to the second gateway (e.g., to point to the BMAC address of the second gateway). In other words, a database of the access node (e.g., the FIB (e.g., a MAC table)) can include the mapping of the CMAC address to the BMAC addresses of the first gateway (e.g., the closer gateway) that will have the higher priority. The other database of the access node (e.g., the LSDB) can include information (e.g., the mapping of the CMAC address to the BMAC addresses) of the second gateway (e.g., the farther gateway) that will have the lower priority.

Method 200 can further include operations for updating the databases based on the updates to the network (that includes the access node). For example, method 200 can include determining that the first gateway is unavailable and updating the database (e.g., the FIB (e.g., a MAC table)) such that the CMAC address points to the second gateway as the first priority for forwarding packets. Method 200 can further include receiving a third TLV from a third gateway, where the third TLV includes the CMAC address, the IP address, and the L2 I-SID. Method 200 can further include determining that the third gateway is closer to the access node than the first and second gateways and updating the database (e.g., the FIB (e.g., a MAC table)) such that the CMAC address points to the third gateway as the first priority for forwarding packets.

Various aspects may be implemented, for example, using one or more computer systems, such as computer system 300 shown in FIG. 3. One or more computer systems 300 may be used, for example, to implement any aspect of the disclosure discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include customer input/output device(s) 303, such as monitors, keyboards, pointing devices, etc., which may communicate with communication infrastructure 306 through customer input/output interface(s) 302.

One or more of processors 304 may be a graphics processing unit (GPU), an application-specific integrated circuit (ASIC), a neural processing unit (NPU), and/or a central processing unit (CPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (e.g., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture including a tangible, non-transitory computer useable or readable medium having control logic (software) stored thereon may also be referred to herein as a “computer program product” or “program storage device.” This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 3. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A method for using gateways in a Shortest Path Bridging (SPB) network, the method comprising:
receiving, by an access node, a first Type-Length-Value (TLV) from a first gateway, wherein the first TLV comprises a Client Media Access Control (CMAC) address for the first gateway, an Internet Protocol (IP) address of the first gateway, and a layer 2 (L2) Instance Service Identifiers (I-SID) associated with the first gateway;
receiving, by the access node, a second TLV from a second gateway, wherein the second TLV comprises the CMAC address, the IP address, and the L2 I-SID;
in response to determining that the L2 I-SID exists in Link State Databases (LSDB) of the access node, determining that the first gateway is closer to the access node than the second gateway; and
storing the CMAC address in a database to point to the first gateway based on the determination.

2. The method of claim 1, wherein the first gateway has a first priority for forwarding the packet and the second gateway has a second priority for forwarding the packet.

3. The method of claim 2, further comprising:
determining that the first gateway is unavailable; and
updating the database such that the CMAC address points to the second gateway as the first priority for forwarding the packet.

4. The method of claim 2, further comprising:
receiving a third TLV from a third gateway, wherein the third TLV comprises the CMAC address, the IP address, and the L2 I-SID;
determining that the third gateway is closer to the access node than the first and second gateways; and
updating the database such that the CMAC address points to the third gateway as the first priority for forwarding the packet.

5. The method of claim 1, further comprising:
determining a first cost metric associated with the first gateway;
determining a second cost metric associated with the second gateway; and
in response to the second cost metric being greater than the first cost metric, determining that the first gateway is closer to the access node than the second gateway.

6. The method of claim 5, wherein:
the first TLV further comprises a first cost value,
the second TLV further comprises a second cost value,
determining the first cost metric comprises determining a first combination of the first cost value and a cost value of a first link between the access node and the first gateway, and
determining the second cost metric comprises determining a second combination of the second cost value and a cost value of a second link between the access node and the second gateway.

7. The method of claim 6, wherein the first gateway and the access node are located in a first network area in a multi-area network and the second gateway is located in a second network area of the multi-area network, and wherein the second network area is different from the first network area.

8. An access node comprising:
a memory;
at least one processor coupled to the memory and configured to:
receive a first Type-Length-Value (TLV) from a first gateway, wherein the first TLV comprises a Client Media Access Control (CMAC) address for the first gateway, an Internet Protocol (IP) address of the first gateway, and a layer 2 (L2) Instance Service Identifiers (I-SID) associated with the first gateway;
receive a second TLV from a second gateway, wherein the second TLV comprises the CMAC address, the IP address, and the L2 I-SID;
in response to determining that the L2 I-SID exists in Link State Databases (LSDB) of the access node, determine that the first gateway is closer to the access node than the second gateway; and
store the CMAC address in a database to point to the first gateway based on the determination.

9. The access node of claim 8, wherein the first gateway has a first priority for forwarding the packet and the second gateway has a second priority for forwarding the packet.

10. The access node of claim 9, wherein the at least one processor is further configured to:
determine that the first gateway is unavailable; and
update the database such that the CMAC address points to the second gateway as the first priority for forwarding the packet.

11. The access node of claim 9, wherein the at least one processor is further configured to:
receive a third TLV from a third gateway, wherein the third TLV comprises the CMAC address, the IP address, and the L2 I-SID;
determine that the third gateway is closer to the access node than the first and second gateways; and
update the database such that the CMAC address points to the third gateway as the first priority for forwarding the packet.

12. The access node of claim 8, wherein the at least one processor is further configured to:
determine a first cost metric associated with the first gateway;
determine a second cost metric associated with the second gateway; and
in response to the second cost metric being greater than the first cost metric, determine that the first gateway is closer to the access node than the second gateway.

13. The access node of claim 12, wherein:
the first TLV further comprises a first cost value,
the second TLV further comprises a second cost value,
to determine the first cost metric, the least one processor is configured to determine a first combination of the first cost value and a cost value of a first link between the access node and the first gateway, and
to determine the second cost metric, the least one processor is configured to determine a second combination of the second cost value and a cost value of a second link between the access node and the second gateway.

14. The access node of claim 13, wherein the first gateway and the access node are located in a first network area in a multi-area network and the second gateway is located in a second network area of the multi-area network, and wherein the second network area is different from the first network area.

15. A tangible computer-readable device having instructions stored thereon that, when executed by at least one processor of an access node, cause the at least one processor to perform operations comprising:
receiving a first Type-Length-Value (TLV) from a first gateway, wherein the first TLV comprises a Client Media Access Control (CMAC) address for the first gateway, an Internet Protocol (IP) address of the first gateway, and a layer 2 (L2) Instance Service Identifiers (I-SID) associated with the first gateway;
receiving a second TLV from a second gateway, wherein the second TLV comprises the CMAC address, the IP address, and the L2 I-SID;
in response to determining that the L2 I-SID exists in Link State Databases (LSDB) of the access node, determining that the first gateway is closer to the access node than the second gateway; and
storing the CMAC address in a database to point to the first gateway based on the determination.

16. The tangible computer-readable device of claim 15, wherein the first gateway has a first priority for forwarding the packet and the second gateway has a second priority for forwarding the packet.

17. The tangible computer-readable device of claim 16, the operations further comprising:
determining that the first gateway is unavailable; and
updating the database such that the CMAC address points to the second gateway as the first priority for forwarding the packet.

18. The tangible computer-readable device of claim 17, the operations further comprising:
receiving a third TLV from a third gateway, wherein the third TLV comprises the CMAC address, the IP address, and the L2 I-SID;
determining that the third gateway is closer to the access node than the first and second gateways; and
updating the database such that the CMAC address points to the third gateway as the first priority for forwarding the packet.

19. The tangible computer-readable device of claim 15, the operations further comprising:
determining a first cost metric associated with the first gateway;
determining a second cost metric associated with the second gateway; and
in response to the second cost metric being greater than the first cost metric, determining that the first gateway is closer to the access node than the second gateway.

20. The tangible computer-readable device of claim 19, wherein:
the first TLV further comprises a first cost value,
the second TLV further comprises a second cost value,
determining the first cost metric comprises determining a first combination of the first cost value and a cost value of a first link between the access node and the first gateway, and
determining the second cost metric comprises determining a second combination of the second cost value and a cost value of a second link between the access node and the second gateway.
